(19) United States
(12) Patent Application Publication
(10) Pub. No.: US 2025/0356250 A1
(43) Pub. Date: Nov. 20, 2025

(54) Computing System with Functionality Related to a Machine-Learning Model Store

(71) Applicant: Roku, Inc., San Jose, CA (US)

(72) Inventors: Greg Garner, Key Colony Beach, FL (US); Soren Riise, San Jose, CA (US); Patrick A. Brouillette, Tempe, AZ (US); Robert Caston Curtis, Napa, CA (US); Sunil Ramesh, Cupertino, CA (US); David Stern, San Jose, CA (US); Carl Sassenrath, Reno, NV (US)

(21) Appl. No.: 18/667,823

(22) Filed: May 17, 2024

(51) Int. Cl. G06N 20/00

(52) U.S. Cl. CPC G06N 20/00

(57) ABSTRACT

In one aspect, an example method involves: receiving a request to train a model and prompting a user for a first input indicating a subject for detection within media; receiving the first input; using at least the received first input as a basis to obtain a set of media related to the subject for detection; outputting the obtained set of media and prompting the user for second input indicating subject identification information; receiving the second input; using at least (i) the obtained set of media as training input data and (ii) the received second input as training output data, to train the model; and performing operations to facilitate causing a computing system to run the trained model, wherein the computing system running the trained model comprises the computing system using at least the trained model and received runtime input data to generate and output corresponding runtime output data.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method is disclosed. The method includes: (i) receiving a request to train a machine learning (ML) model and responsively prompting a user for first input indicating a subject for detection within media; (ii) receiving, via a user interface, the first input; (iii) using at least the received first input as a basis to obtain a set of media related to the subject for detection; (iv) outputting, via the user interface, the obtained set of media and prompting the user for second input indicating subject identification information relating to the subject for detection within the obtained set of media; (v) receiving, via the user interface, the second input; (vi) using at least (a) the obtained set of media as training input data and (b) the received second input as training output data, to train the ML model; and (vii) performing a set of operations to facilitate causing a computing system to run the trained ML model, wherein the computing system running the trained ML model involves the computing system using at least the trained ML model and received runtime input data to generate and output corresponding runtime output data.

In another aspect, an example computing system is disclosed. The computing system includes a processor and a non-transitory computer-readable storage medium having stored thereon program instructions that upon execution by the processor, cause the computing system to perform a set of acts including: (i) receiving a request to train a ML model and responsively prompting a user for first input indicating a subject for detection within media; (ii) receiving, via a user interface, the first input; (iii) using at least the received first input as a basis to obtain a set of media related to the subject for detection; (iv) outputting, via the user interface, the obtained set of media and prompting the user for second input indicating subject identification information relating to the subject for detection within the obtained set of media; (v) receiving, via the user interface, the second input; (vi) using at least (a) the obtained set of media as training input data and (b) the received second input as training output data, to train the ML model; and (vii) performing a set of operations to facilitate causing a computing system to run the trained ML model, wherein the computing system running the trained ML model involves the computing system using at least the trained ML model and received runtime input data to generate and output corresponding runtime output data.

In another aspect, an example non-transitory computer-readable medium is disclosed. The computer-readable medium has stored thereon program instructions that upon execution by a processor, cause a computing system to perform a set of acts including: (i) receiving a request to train a ML model and responsively prompting a user for first input indicating a subject for detection within media; (ii) receiving, via a user interface, the first input; (iii) using at least the received first input as a basis to obtain a set of media related to the subject for detection; (iv) outputting, via the user interface, the obtained set of media and prompting the user for second input indicating subject identification information relating to the subject for detection within the obtained set of media; (v) receiving, via the user interface, the second input; (vi) using at least (a) the obtained set of media as training input data and (b) the received second input as training output data, to train the ML model; and (vii) performing a set of operations to facilitate causing a computing system to run the trained ML model, wherein the computing system running the trained ML model involves the computing system using at least the trained ML model and received runtime input data to generate and output corresponding runtime output data.

In one aspect, an example method is disclosed. The method includes: (i) obtaining computing system profile data associated with at least one computing system; (ii) using the obtained computing system data as a basis to select, from among a set of multiple ML models each having corresponding model profile data, a subset of ML models based on a match between the obtained computing system profile data and the model profile data; (iii) outputting, via a user interface, displayable representations of the ML models in the selected subset of ML models and prompting a user for input indicating a selection of at least one ML models from the selected subset of ML models; (iv) receiving, via the user interface, the input indicating a selection of at least one ML model from the selected subset of ML models; and (v) performing a set of operations to facilitate causing a computing system to run the selected at least one ML model, wherein the computing system running the at least one ML model involves the computing system using the at least one ML model and received runtime input data to generate and output corresponding runtime output data.

In another aspect, an example computing system is disclosed. The computing system includes a processor and a non-transitory computer-readable storage medium having stored thereon program instructions that upon execution by the processor, cause the computing system to perform a set of acts including: (i) obtaining computing system profile data associated with at least one computing system; (ii) using the obtained computing system data as a basis to select, from among a set of multiple ML models each having corresponding model profile data, a subset of ML models based on a match between the obtained computing system profile data and the model profile data; (iii) outputting, via a user interface, displayable representations of the ML models in the selected subset of ML models and prompting a user for input indicating a selection of at least one ML models from the selected subset of ML models; (iv) receiving, via the user interface, the input indicating a selection of at least one ML model from the selected subset of ML models; and (v) performing a set of operations to facilitate causing a computing system to run the selected at least one ML model, wherein the computing system running the at least one ML model involves the computing system using the at least one ML model and received runtime input data to generate and output corresponding runtime output data.

In another aspect, an example non-transitory computer-readable medium is disclosed. The computer-readable medium has stored thereon program instructions that upon execution by a processor, cause a computing system to perform a set of acts including: (i) obtaining computing system profile data associated with at least one computing system; (ii) using the obtained computing system data as a basis to select, from among a set of multiple ML models each having corresponding model profile data, a subset of ML models based on a match between the obtained computing system profile data and the model profile data; (iii) outputting, via a user interface, displayable representations of the ML models in the selected subset of ML models and prompting a user for input indicating a selection of at least one ML models from the selected subset of ML models; (iv) receiving, via the user interface, the input indicating a selection of at least one ML model from the selected subset of ML models; and (v) performing a set of operations to facilitate causing a computing system to run the selected at least one ML model, wherein the computing system running the at least one ML model involves the computing system using the at least one ML model and received runtime input data to generate and output corresponding runtime output data.

### BRIEF DESCRIPTION OF THE DRAWINGS

FIG. 1 is a simplified block diagram of an example machine learning (ML) system in which various described principles can be implemented.

FIG. 2 is a simplified block diagram of an example computing system in which various described principles can be implemented.

FIG. 3 is a flow chart of an example method.

FIG. 4 is a flow chart of another example method.

FIG. 5 is a flow chart of another example method.

FIG. 6 is a flow chart of another example method.

### DETAILED DESCRIPTION

### I. Overview

Disclosed herein is a machine learning (ML) system that can perform operations related to ML models. The ML system can include various components, such as an ML model manager and an Internet-of-Things (IoT) device, such as a camera. In one example, the ML model manager can perform operations related to administering and/or providing user or device access to a ML model store, which can include operations such as adding trained ML models to the ML model store, training new or existing ML models, selecting trained ML models, and/or facilitating causing trained ML models to be provided to and/or used by devices, such as the IoT device. Accordingly, in various examples, these and other operations can facilitate the IoT device and/or other computing systems running trained models obtained from the ML model store, which in turn can allow the IoT device and/or other computing systems to perform certain operations that leverage the use of trained ML models in a manner that provides various features and benefits to end-users.

In one aspect, the ML model store can facilitate training a ML model, which can then be added to the ML model store. In one example, to do this, the ML model manager can receive a request to train an ML model and in response to receiving the request, the ML model manager can prompt a user for a first input indicating a subject for detection within media. The ML model manager can then receive, via the user interface, the first input and can use at least the received first input as a basis to obtain a set of media related to the subject for detection. The ML model manager can then output, via the user interface, the obtained set of media and can prompt the user for second input indicating subject identification information relating to the subject for detection within the obtained set of media. The ML model manager can then receive, via the user interface, the second input. The ML model manager can use at least (i) the obtained set of media as training input data and (ii) the received second input as training output data, to train the ML model.

In another aspect, the ML model manager can organize the various trained ML models that have been added to the ML model store and can provide a user interface through which the ML model manager and/or a user can perform certain operations, such as browsing and/or searching for (e.g., by entering/selecting search terms or other searching criteria), and/or selecting one or more trained ML models for use in connection with a given device, such as the IoT device. In some cases, this can involve the ML model manager performing one or more operations to filter options presented to the user, such that the ML model manager can provide a set of selectable ML models based on characteristics of one or more IoT devices or other computing systems that the ML models might be used with.

In one example, to do this, the ML model manager can obtain computing system profile data associated with at least one computing system (e.g., with the IoT device). The ML model manager can use the obtained computing system data as a basis to select, from among a set of multiple ML models each having corresponding model profile data, a subset of ML models based on a match between the obtained computing system profile data and the model profile data. Thus, for example, if a given computing system has certain computing resource requirements or preferences, the ML model manager can take those into account and filter the list of trained ML models down to ones that have computing resource characteristic that match those requirements or preferences.

The ML model manager can output, via a user interface, displayable representations of the ML models in the selected subset of ML models and can prompt the user for input indicating a selection of at least one ML models from the selected subset of ML models. The ML model manager can receive, via the user interface, the input indicating a selection of at least one ML model from the selected subset of ML models. The ML model manager can then perform a set of operations to facilitate causing the IoT device (or another computing system) to run the selected trained ML model, as outlined above.

The disclosure also provides other related concepts and features. These and related examples and operations will now be described in greater detail.

### II. Example Architecture

### A. Machine Learning (ML) System

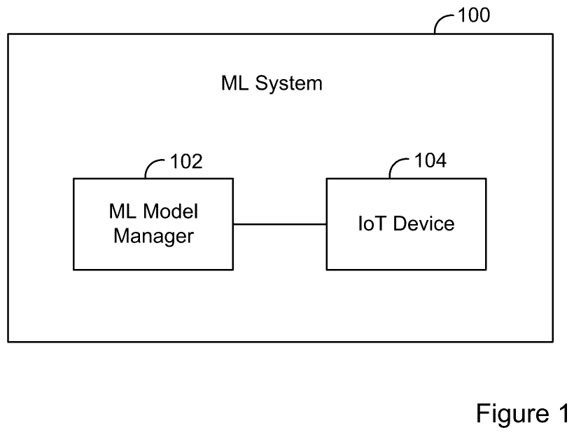

FIG. 1 is a simplified block diagram of an example machine learning (ML) system 100. Generally, the ML system 100 can perform operations related to ML models. The ML system 100 can include various components, such as an ML model manager 102 and an Internet-of-Things (IoT) device 104. In one example, the ML model manager 102 can perform operations related to administering and/or providing user or device access to a ML model store, which can include operations such as adding trained ML models to the ML model store, training new or existing ML models, selecting trained ML models, and/or facilitating causing trained ML models to be provided to and/or used by devices, such as the IoT device 104. Accordingly, in various examples, these and other operations can facilitate the IoT device 104 and/or other computing systems running trained models obtained from the ML model store, which in turn can allow the IoT device 104 and/or other computing systems to perform certain operations that leverage the use of trained ML models in a manner that provides various features and benefits to end-users.

The IoT device 104 can take various forms. For example, the IoT device 104 can be or include a camera, a microphone, a motion sensor, a light sensor, a temperature sensor, a humidity sensor, a television, a sound speaker, a streaming media player, and/or a set-top box, among numerous other possibilities, including any kind of IoT device or computing system. In practice, one or more of these example types can be integrated with another. For instance, in one example, an IoT device 104 can take the form of a television with integrated camera and microphone components.

The ML system 100 can also include one or more connection mechanisms that connect various components within the ML system 100. For example, the ML system 100 can include the connection mechanisms represented by lines connecting components of the ML system 100, as shown in FIG. 1.

In this disclosure, the term “connection mechanism” means a mechanism that connects and facilitates communication between two or more devices, systems, other entities, and/or components thereof. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

In some instances, the ML system 100 and/or components thereof can include multiple instances of at least some of the described components. The ML system 100 and/or components thereof can take the form of a computing system, an example of which is described below.

### B. Computing System

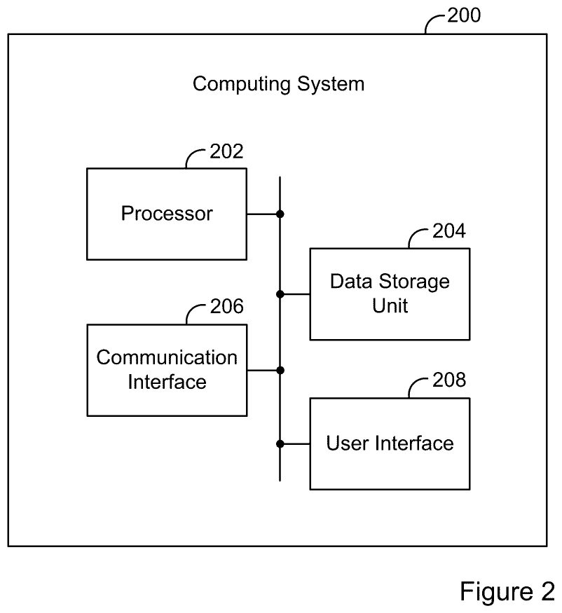

FIG. 2 is a simplified block diagram of an example computing system 200. The computing system 200 can be configured to perform and/or can perform various operations, such as the operations described in this disclosure. The computing system 200 can include various components, such as: a processor 202, a data storage unit 204, a communication interface 206, and/or a user interface 208.

The processor 202 can be, or include, a general-purpose processor (e.g., a microprocessor) and/or a special-purpose processor (e.g., a digital signal processor). The processor 202 can execute program instructions included in the data storage unit 204 as described below.

The data storage unit 204 can be or include one or more volatile, non-volatile, removable, and/or non-removable storage components, such as magnetic, optical, and/or flash storage, and/or can be integrated in whole or in part with the processor 202. Further, the data storage unit 204 can be, or include, a non-transitory computer-readable storage medium, having stored thereon program instructions (e.g., compiled or non-compiled program logic and/or machine code) that, upon execution by the processor 202, cause the computing system 200 and/or another computing system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface or a High-Definition Multimedia Interface (HDMI). In another example, the communication interface 206 can be or include a wireless interface, such as a cellular or Wi-Fi interface.

The user interface 208 can allow for interaction between the computing system 200 and a user of the computing system 200. As such, the user interface 208 can be or include an input component such as: a keyboard, a mouse, a remote controller, a microphone, and/or a touch-sensitive panel. The user interface 208 can also be or include an output component such as a display screen (which, for example, can be combined with a touch-sensitive panel), one or more projectors (e.g., for projecting supplemental video content, as described in greater detail below), and/or a sound speaker. The display screen can have a display area (where video content can be displayed), and that display area can have an aspect ratio.

In some cases, the computing system 200 can include one or more components that make the computing system 200 especially suited to perform operations related to ML models, such as to train ML models and/or to run trained ML models. Such components can include ML-specific versions of the various example components described above (e.g., an ML-specific processor such as a ML-specific graphics-processing unit (GPU), an ML-specific data storage unit, etc.) and/or other ML-specific components, among numerous other possibilities.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, such as a partially or fully cloud-based arrangement, for instance.

As noted above, the ML system 100 and/or components of the ML system 100 can take the form of a computing system, such as the computing system 200. In some cases, some or all of these entities can take the form of a more specific type of computing system, such as a desktop or workstation computer, a laptop, a tablet, a mobile phone, and/or a head-mountable display device (e.g., virtual-reality headset or an augmented-reality headset), among numerous other possibilities.

### III. Example Operations

The ML system 100, the computing system 200, and/or components of either can be configured to perform and/or can perform various operations. For example, the ML model manager 102 can perform operations related to administering and/or providing user access to a ML model store via a user interface (e.g., via a web-based graphical user interface).

As noted above, in one aspect, the ML system 100 can administer a ML model store, which in some contexts might alternatively be considered a ML model platform, a ML model marketplace, or the like, any of which can allow a given party to add trained ML models to the ML model store, such that they can then be obtained for use in connection with a device or computing system, such as the IoT device 104. In practice, the party who adds trained models to the ML model store can be the same party that administers the ML model store (which could be a manufacturer or provider of televisions, set-top boxes, or other devices such as the IoT device 104 through which the ML store can be accessed, and/or a manufacturer or provider of the operating system software that runs on such devices, as just a few examples). However, the party who adds trained models to the ML store might be a different party (e.g., a third-party) as well.

Generally, the trained ML models can be configured in various ways and can be used for various purposes, such as to add new features and/or functionality to, or to enhance existing features and/or functionality of, the IoT device 104 or another computing system.

For example, consider a scenario in which the IoT device 104 is a camera that a user installs in their home such that it captures video of the user's front yard for use as a security camera and for general monitoring purposes. In this case, the user might interested in having the camera detect the presence of a postal package, such that the user can be alerted when the package is dropped off in front of their house, but the camera may not provide such detection functionality out-of-the box. In this scenario, an ML provider party such as the manufacture or provider of the camera or some third-party ML model developer can train a model that is configured to receive video as input and that can provide package identification information as output. Such package identification information might be in the form of a timestamp indicating when within the video a package has been detected. The package identification information might include additional or alternative details as well, such as information about what regions within a given frame or portion of the video the package has been detected. In one example, the ML model provider can train the model for this specific purpose and add it to the ML store, such that it can be obtained and ultimately used in connection with the IoT device 104 (e.g., installed on and executed by the IoT device) such that the IoT device 104 can leverage the trained ML model to provide the described functionality.

Notably though, before a ML model can be used for this or any other intended purpose, the ML model may first need to be trained, which the ML model provider or another party can do by providing it with training input data and corresponding training output data.

For example, in the example noted above in which the ML model is intended to detect the presence of packages in video, the ML model could be trained by being provided with training input data in the form of video, together with corresponding training output data in the form of package identification information. As such, for example, a first set of training input data could include video of a user's front yard without a package, and a corresponding second set of training output data could include package identification information indicating that the video does not include a package. As another example, a second set of training input data could include video of the user's front yard with a package positioned in a given location in the yard, and a corresponding second set of training output data could include package identification information indicating that the video includes a package, perhaps with additional information specifying where within the video the package is positioned.

In practice, it is likely that large amounts of training data—perhaps thousands of training data sets or more—would be used to train a given ML model as this generally helps improve the usefulness of the model. Training data can be generated in various ways, including by being manually assembled. However, in some cases, the one or more tools or techniques, including any training data gathering or organization techniques now known or later discovered, can be used to help automate or at least partially automate the process of assembling training data and/or training the ML model.

Notably, ML models can also be trained by employing unsupervised learning techniques, by modifying a previously trained model (e.g., by reducing parameters or tweaking weights/biases), or by employing any other training technique, including any training techniques now known or later discovered. Moreover, it should be noted that such training could be performed by various systems or devices, such as the model manager 102, the IoT device 104, and/or a dedicated cloud-based training server, among other possibilities.

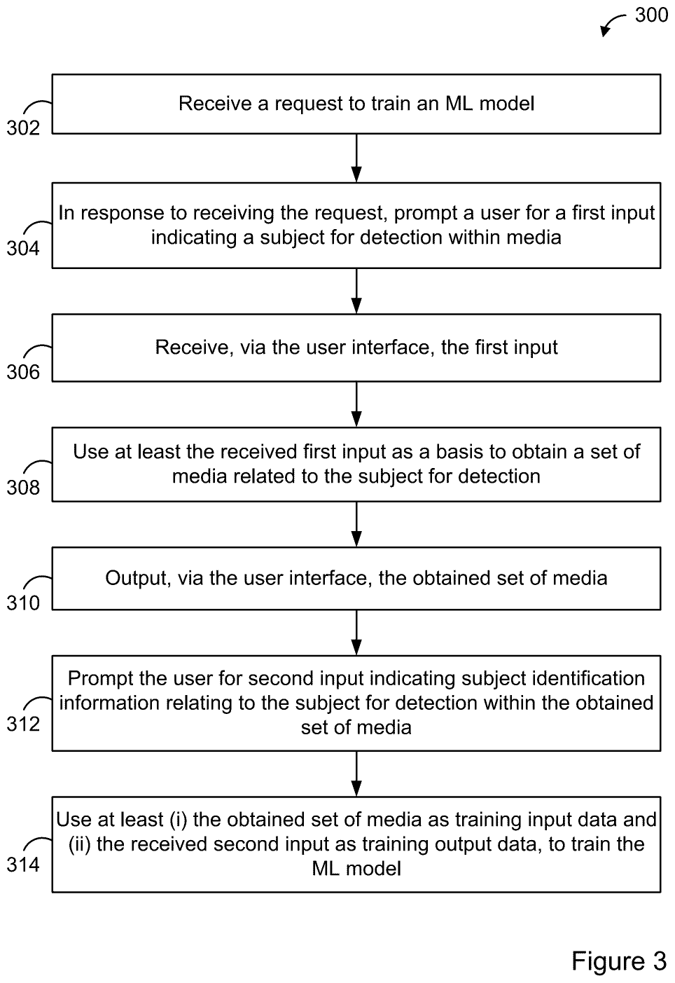

In some situations, the ML model store can facilitate training a ML model, which can then be added to the ML model store. The ML model manager 102 can do this in various ways, such as by performing one or more of the operations described below and in connection with FIG. 3, which is a flow chart illustrating an example method 300.

To begin, at block 302, the ML model manager 102 can receive a request to train an ML model. In one example, the ML model manager 102 can receive this request in the form of input provided by a user via a user interface. But in other examples, the request can be automatically generated based on one or more trigger events, such as a user searching for a ML model based on certain keywords, with no matching results being found.

At block 304, in response to receiving the request, the ML model manager 102 can prompt a user for a first input indicating a subject for detection within media. For example, returning to the camera example discussed above, consider a situation in which, rather that wanting to detect packages, the user seeks to detect deer walking through the user's front year. In this case, the user could provide a first input with certain text, such as “deer” or other relevant keywords (perhaps indicating a more specific type or species of deer, such as “red deer” or “white-tailed deer”).

At block 306, the ML model manager 102 can then receive, via the user interface, the first input.

At block 308, the ML model manager 102 can use at least the received first input as a basis to obtain a set of media related to the subject for detection. The ML model manager 102 can do this in various ways. For example, this can involve the ML model manager 102 using at least the received first input to search for and obtain example media representing the subject for detection. As such, continuing with the example above, the ML model manager 102 could use the text “deer” to search for and obtain example images of deer. Such media could be obtained from various sources, such as the user's historical data, or a media database/repository, for example.

At block 310, the ML model manager 102 can output, via the user interface, the obtained set of media. For example, in the case where the media is a set of images of deer, the ML model manager 102 can output each image in the set, perhaps one at a time in a linear fashion, in a grid-like fashion, or in another way that allows the user to review and consider each image, and provide corresponding input as discussed below.

In connection with outputting the obtained set of images, at block 312, the ML model manager 102 can also prompt the user for second input indicating subject identification information relating to the subject for detection within the obtained set of media. And the ML model manager 102 can then receive, via the user interface, the second input.

The prompting and corresponding subject identification information can take various forms. For example, for each image presented to the user, the ML model manager 102 can prompt the user to merely indicate “yes” or” “no” indicating whether the image includes a deer. However, in other example, the user can be prompted to provide more specific input, such as input indicating a type or species of the deer, or an indication as to where within the image the deer is positioned, among numerous other possibilities.

At block 314, the ML model manager 102 can use at least (i) the obtained set of media as training input data and (ii) the received second input as training output data, to train the ML model.

Notably, although this one example of training a ML model has been provided, many other example implementations and use cases are possible as well. For example, a user can specify a variety of different types of subjects to be detected in a variety of different types of media (e.g., people or objects in video or images, certain sounds within audio, and/or or a portion or combination thereof). Likewise, the obtained set of media and the subject identification information can take various forms as well, perhaps based on the type of subject being detected and/or based on the type of media that the subject is being detected within.

For example, in the case where the media is video, the set of media might include multiple images, and the subject identification information might specify whether, for each of the multiple images, the subject for detection is represented within that respective image, and/or where the subject for detection is represented within that respective image. As another example, in the case where the media is audio, the set of media includes can include multiple audio clips, and the subject identification information can specify whether, for each of the multiple audio clips, the subject for detection is represented within that respective audio clip.

In some examples, the ML model manager 102 can leverage the fact that the user has a camera or other media-capturing device that might be capturing media that represents the subject sought to be detected. For instance, in the example illustrated above in which a user has a camera for which the user is seeking a trained ML model, it could be advantageous for the obtained set of media to include media captured by that camera. As such, in one aspect, the ML model manager can identify a camera or other media-capturing device associated with the user (e.g., based on user and/or device profile data). In that case, the step of the ML model manager 102 using at least the received first input as a basis to obtain the set of media related to the subject for detection can involve the ML model manager 102 using at least the received first input to search, within media captured by the identified media-capturing device, for media to include in the obtained set of media.

In some examples, the ML model manager 102 can synthetically generate media to be included in the obtained set of media. For instance, in the example illustrated above in which a user has a camera for which the user is seeking a trained ML model, it could be advantageous for the obtained set of media to include synthetically generated video representing a deer positioned within the user's front yard. As such, in one aspect, the ML model manager 102 using at least the received first input as a basis to obtain the set of media related to the subject for detection can involve the ML model manager 102 (i) using at least the received first input to search for and obtain example media representing the subject for detection; (ii) identifying a media-capturing device associated with the user and obtaining media captured by the identified media-capturing device; and (iii) using at least (a) the obtained example media representing the subject for detection and (b) the obtained media captured by the identified media-capturing device, to synthetically generate media that includes (a) the obtained example media representing the subject for detection and (b) the obtained media captured by the identified media-capturing device. To do this, the ML model manager 102 can use any synthetic media generation technique (which itself may leverage use of a ML model) now known or later discovered.

In some examples, the ML model manager 102 can leverage user profile data and/or computing system profile data to help obtain a more tailored set of media related to the subject for detection. For instance, in the example illustrated above in which the IoT device 104 is a camera that the user is seeking to train a ML model to be used with, it could be advantageous for the ML model manager 102 to use user profile data associated with the user and/or computing system profile data associated with the IoT device 104 to select more relevant media related to the subject for detection. For example, consider an example in which the corresponding user profile data indicates a geographic location of the user, or the corresponding computing system profile data indicates a geographic location of the IoT device 104. In this case, the ML model manager 102 can use that geographic location to obtain images of deer that are known to be located in that particular geographic region of the user/system. This can result in more accurate training data, which in turn can result in a more effective and useful trained ML model.

As such, in line with the discussion above, in one example, the ML model manager 102 can obtain user profile data associated with the user. In this case, the step of the ML model manager 102 using at least the received first input as the basis to obtain the set of media related to the subject for detection can involve the ML model manager 102 using at least the received first input and the obtained user profile data as a basis to obtain the set of media related to the subject for detection.

Likewise, in line with the discussion above, in another example, the ML model manager 102 can obtain computing system profile data associated with the IoT device 104 or another computing system. In this case, the step of the ML model manager 102 using at least the received first input as the basis to obtain the set of media related to the subject for detection can involve the ML model manager 102 using at least the received first input and the obtained computing system profile data as a basis to obtain the set of media related to the subject for detection.

Notably, such user profile data and/or computing system profile data can be obtained, stored, organized, and retrieved in various ways, such as by using any related profile data technique now known or later discovered. In some instances, profile data can be obtained, stored, and/or used only after the user has provided explicit permission for such operations to be performed. Likewise, in some cases, various other features and/or operations disclosed herein can be provided/performed only after the user has provided explicit permission to do so. Notably, user profile data can also be used to store user or computing system settings for various configurations (e.g., to enable or disable one or more features, such as those disclosed herein).

Returning back to the discussion about adding a trained ML model to the ML model store, in connection with this (whether adding an ML model that has been pre-trained by the ML model provider or that is trained with help from the ML model store as discussed above), model profile data can be associated with the ML model.

This model profile data can be provided by the ML model provider and/or generated by the ML model manager 102 (e.g., based on user input received and/or based on analysis of the trained ML model and/or devices that the ML models is intended to be used in connection with), and then stored in a data storage unit (e.g., of the ML model manager), with mapping data to reflect the association, according to various examples. The model profile data can take various forms and can specify various properties and/or other metadata for the ML model. For example, the model profile data can specify at least one computing resource requirement or preference for the trained ML model. As such, the model profile data could specify that certain device hardware components (perhaps of a specific type, model, etc.) are required or preferred in order to run the trained ML model. For instance, the model profile data could specify that for the ML model to be run on a given device, such as the IoT device 104, that device should/must have a ML-specific processor such as a ML-specific graphics-processing unit (GPU), or a specific amount of data storage available within a data storage unit.

In other examples, the model profile data could specify that the ML model is configured for use with a specific type or model of device, such as for use only with cameras of a given model line manufactured by a given brand, or that have a frame rate within a given range, as just a few examples. In other examples, the model profile data can specify that the ML model is compatible with multiple different devices and/or hardware configurations, but that might specify different model configurations depending on the given device and/or hardware properties. This could ensure that the model operates differently depending on the properties of the device that the model is used for, in one example implementation.

The ML model manager 102 can organize the various trained ML models that have been added to the ML model store and can provide a user interface through which the ML model manager 102 and/or a user can perform certain operations, such as browsing and/or searching for (e.g., by entering/selecting search terms or other searching criteria), and/or selecting one or more trained ML models for use in connection with a given device, such as the IoT device 104.

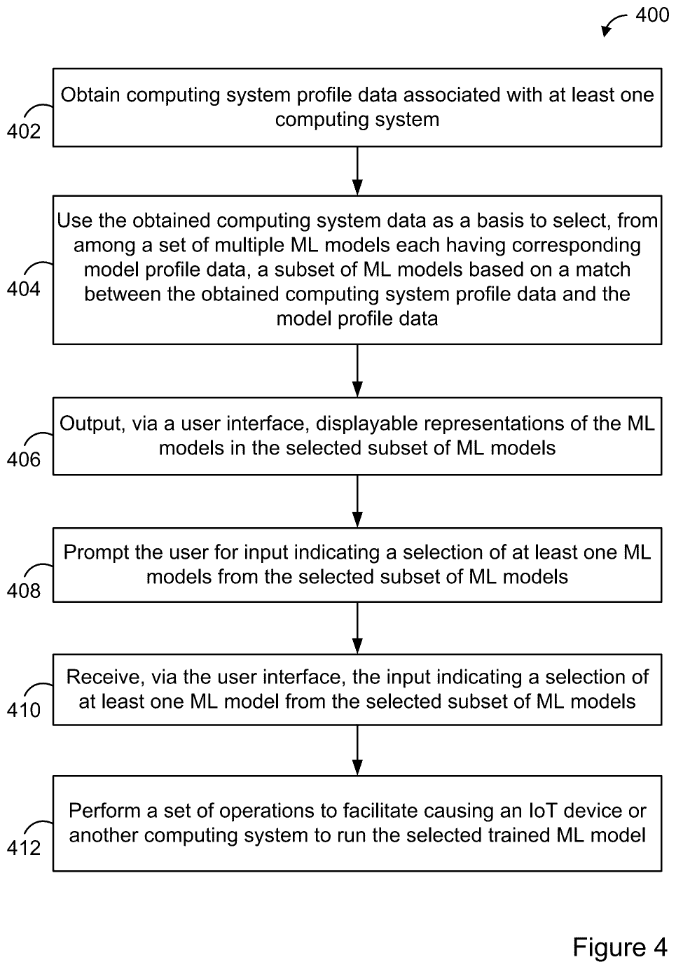

In one aspect, the ML model manager 102 can perform one or more operations to filter options presented to the user, such that the ML model manager 102 can provide a set of selectable ML models based on characteristics of one or more IoT devices or other computing systems that the ML models might be used with. These and related options will now be described in greater detail below and in connection with FIG. 4, which is a flow chart illustrating an example method 400.

At block 402, the ML model manager 102 can obtain computing system profile data associated with at least one computing system (e.g., with the IoT device 104). In one example, the computing system profile data can specify at least one computing resource characteristic of the at least one computing system. As such, computing system profile data can specify a type of processor, data storage unit, a speed of the processor, and/or an amount of data store that is available, among numerous other possibilities.

At block 404, the ML model manager 102 can use the obtained computing system data as a basis to select, from among a set of multiple ML models each having corresponding model profile data, a subset of ML models based on a match between the obtained computing system profile data and the model profile data. Thus, for example, if a given computing system has certain computing resource requirements or preferences, the ML model manager 102 can take those into account and filter the list of trained ML models down to ones that have computing resource characteristic that match those requirements or preferences.

At block 406, the ML model manager 102 can output, via a user interface, displayable representations of the ML models in the selected subset of ML models.

At block 408, the ML model manager 102 can prompt the user for input indicating a selection of at least one ML models from the selected subset of ML models.

In some examples, the ML model manager 102 can determine at least one computing system associated with the user (e.g., IoT devices in the user's home). In this case, the step of obtaining computing system profile data associated with at least one computing system can involve obtaining computing system profile data associated with the determined at least one computing system associated with the user. In practice, this can allow the ML model manager 102 to filter the trained ML model options provided to the user, such that the user sees only trained ML models that are compatible with computing systems associated with the user.

In other examples, the ML model manager 102 can determine at least one computing system in which the user has expressed interest. In this case, the step of obtaining computing system profile data associated with at least one computing system can involve obtaining computing system profile data associated with the determined at least one computing system in which the user has expressed interest. In practice, this can allow the ML model manager 102 to filter the trained ML model options provided to the user, such that the user sees only trained ML models that the user has indicated an interested in (e.g., which the user can be considering purchasing, etc.).

Notably, these are just a few examples. In practice, the ML model manager 102 can determine at least computing system in another way and as such, it can filter the set of selectable trained ML model options in other ways as well.

In any case, after the ML model manager 102 outputs displayable representations of the ML models and prompts the user for input indicating a selection of at least one of the ML models, through the user interface, the user can then provide input indicating a selection of at least one of those ML models. As such, at block 410, the ML model manager 102 can receive, via the user interface, the input indicating a selection of at least one ML model from the selected subset of ML models.

Notably, in the case where a user is not able to find a suitable trained ML model to select, the user may seek to leverage the ML model store to train a ML model to suit the user's needs, which the ML model manager 102 can facilitate using the one or more of the ML model training techniques described above. Based on user input, the ML model manager 102 can then select that newly trained ML model.

Regardless of how the trained ML model is selected, after that occurs, at block 412, the ML model manager 102 can perform a set of operations to facilitate causing the IoT device 104 (or another computing system) to run the selected trained ML model. In this context, the IoT device 104 running the trained ML model involves the IoT device 104 using at least the trained ML model and received runtime input data to generate and output corresponding runtime output data. As such, continuing with the example above where the IoT device 104 is a camera and the trained ML model is configured to generate and output package identification information, the camera can run the trained ML model, which can cause the camera to receive video (which it can consider input training data) and use the received video together with the trained ML model to generate and output runtime output data in the form of package identifying information.

In this context, the ML model manager 102 can perform various operations to facilitate causing the IoT device 104 to do this. For instance, in one example implementation, this can involve the ML model manager 102 transmitting an instruction to a ML model server that stores the ML model, where the instructions is configured to cause the server to transmit the trained ML model to the IoT device 104 where it can be run. Additionally or alternatively, this can involve transmitting an instruction to the IoT device 104, where the instructions is configured to cause the IoT device 104 to use at least received runtime input data and the trained ML model to generate and output corresponding runtime output data.

While some examples of trained ML models and use cases (e.g., the detection of packages and deer within video) have been described, the disclosed techniques can be applied in the context of many other ML models (e.g., types of ML models, etc.), and in the context of many different use cases. As one set of example use cases, ML models could be trained for detecting various other subjects/situations in video, such as detecting people, animals, vehicles, fires, water leaks, etc. As another set of example use cases, ML models could be trained for detecting various subjects/situations in audio, such as the sound of a baby crying, a dog barking, a tree falling, high winds, crackling of a fire, etc. Moreover, the described techniques could be used for other purposes beyond detection of subjects/situations in video or audio, and could additionally or alternative be used to detect or measure temperature, humidity levels, water levels, or to provide any other report or feedback, based on sensor data, media, and/or any other kind of suitable input.

To provide for these and other possible use cases, a variety of different types of ML models could be used, including any type of ML model now known or later discovered. Also, the ML models discussed herein can be configured and/or stored in various ways. For example, ML models can be stored in the form of any suitable data structure and/or file format, such as a JSON file, a YAML file, or the like, which can be transmitted (e.g., from a ML model server to the IoT device 104) such that it can be run on one or more devices, as desired.

With all of these described features, in practice, the ML model store could allow for many different parties to provide many different trained ML models that could be used in connection with many different types of IoT devices 104 or other computing systems. In some instances, multiple parties might even add similar types of ML models to the ML model store, such that a user looking for a given type of ML model may have multiple options to choose from.

Moreover, in some instances, in connection with the step of selecting at least one trained ML model in the ML model store, the ML model manager 102 (perhaps based on input from a user) might select multiple ML models, which the ML model manager 102 can combine into a single model using any ML model merging technique now known or later discovered. This can provide for greater customization and efficiency, as a user who may, for example, be interested in detecting both packages and deer, be able to cause the ML model manager 102 to merge the two example ML models discussed above relating to these, such that the user's IoT device 104 can obtain and run a single model that provides the desired functionality of detecting both packages and deer. Notably, in some instances, this merging could occur at the training phase (e.g., by merging one ML model for deer detection and another model for front yard detection and then fine-tuning on a specific front yard, or by generating merged images of deer and front yards and then training). In some instances, ML models could also be merged based on desired properties (e.g., an ability to detect both deer and front yards) and/or based on device constraints.

Moreover, in the context of training ML models, in some cases, the output of one trained ML model can be used to train or to help train another ML model. Consider for example, a situation in which a ML model is trained to use video obtained from a camera to detect birds, and that the camera also has a microphone component. In this case, when the ML model detect birds in video, the audio portion of that video can then be used as training data for an audio-based ML model that likewise detects birds, but based on audio rather than video. This can allow an audio-based ML model to be trained based on output of the video-based ML model. The audio-based ML model might provide the same or similar results as the video-based model, but do so with less computational cost.

Other data could also be useful in training ML models in this context. For example, weather report data could be paired together with weather sensor data to train a model on how to use weather sensor data to predict certain weather conditions, as one possible example.

The ML model store can also provide for various ways in which parties performing operations in connection with ML models can obtain benefits other than just the benefits that flow from the IoT device 104 or other computing system having added or improved functionality. Indeed, in some examples, the ML model store could be administered such that a ML model provider is rewarded with some type of compensation based on activity associated with provided ML models.

For example, the ML model provider could set a price for a given ML model and could be awarded a percentage of that price or another fee when the ML model is purchased. In another example, the ML model provider could be compensated each time the ML model is obtained, run, run successfully (which could be determined in various ways, such as based on end-user feedback, based on a being run with a data set used for testing purposes, or based on a comparison of output generated by other ML models), or based on some other event occurring. Likewise, end-users obtaining ML models and/or causing ML models to be run on their devices could likewise be compensated based on activity associated with ML models, such as based on them evaluating and providing feedback on the ML model's performance (which could be used for additional training of the ML model), for example. Also, in various examples, parties could benefit from data resulting from the various operations described herein and as such, the ML model store could be administered in a way so as to provide suitable data reports to interested parties.

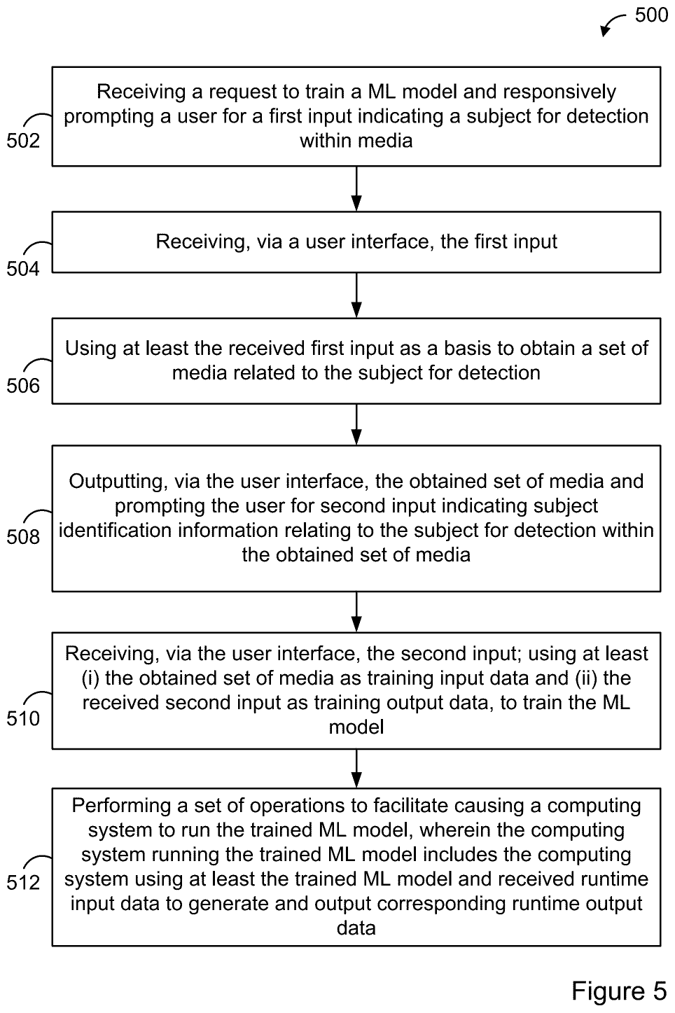

FIG. 5 is a flow chart illustrating an example method 500. The method 500 can be carried out by a ML system, such as the ML system 100 and/or a component thereof, such as the ML model manager 102, or more generally, by a computing system, such as the computing system 200. At block 502, the method 500 includes receiving a request to train a ML model and responsively prompting a user for a first input indicating a subject for detection within media. At block 504, the method 500 includes receiving, via a user interface, the first input. At block 506, the method 500 includes using at least the received first input as a basis to obtain a set of media related to the subject for detection. At block 508, the method 500 includes outputting, via the user interface, the obtained set of media and prompting the user for second input indicating subject identification information relating to the subject for detection within the obtained set of media. At block 510, the method 500 includes receiving, via the user interface, the second input; using at least (i) the obtained set of media as training input data and (ii) the received second input as training output data, to train the ML model. And at block 512, the method 500 includes performing a set of operations to facilitate causing a computing system to run the trained ML model, wherein the computing system running the trained ML model includes the computing system using at least the trained ML model and received runtime input data to generate and output corresponding runtime output data.

In some examples, the media is video, the set of media includes multiple images, and the subject identification information specifies whether, for each of the multiple images, the subject for detection is represented within that respective image.

In some examples, the subject identification information further specifies, for each of the multiple images, where the subject for detection is represented within that respective image.

In some examples, the media is audio, the set of media includes multiple audio clips, and the subject identification information specifies whether, for each of the multiple audio clips, the subject for detection is represented within that respective audio clip.

In some examples, using at least the received first input as a basis to obtain the set of media related to the subject for detection includes: using at least the received first input to search for media to include in the set of media.

In some examples, the method 500 further includes identifying a media-capturing device associated with the user, wherein using at least the received first input as a basis to obtain the set of media related to the subject for detection includes using at least the received first input to search, within media captured by the identified media-capturing device, for media to include in the set of media.

In some examples, using at least the received first input as a basis to obtain the set of media related to the subject for detection includes: using at least the received first input to search for and obtain example media representing the subject for detection; identifying a media-capturing device associated with the user and obtaining media captured by the identified media-capturing device; using at least (i) the obtained example media representing the subject for detection and (ii) the obtained media captured by the identified media-capturing device, to synthetically generate media that includes (i) the obtained example media representing the subject for detection and (ii) the obtained media captured by the identified media-capturing device; and including the synthetically generated media in the obtained set of media.

In some examples, the media-capturing device is a camera.

In some examples, the method 500 further includes: obtaining user profile data associated with the user; wherein using at least the received first input as the basis to obtain the set of media related to the subject for detection includes using at least the received first input and the obtained user profile data as a basis to obtain the set of media related to the subject for detection.

In some examples, the user profile data indicates a geographic location of the user.

In some examples, method 500, further includes: obtaining computing system profile data associated with the computing system; wherein using at least the received first input as the basis to obtain the set of media related to the subject for detection includes: using at least the received first input and the obtained computing system profile data as a basis to obtain the set of media related to the subject for detection.

In some examples, the computing system profile data indicates a geographic location of the computing system.

In some examples, performing the set of operations to facilitate causing the computing system to run the trained ML model comprises transmitting an instruction configured to cause a server to transmit the trained ML model to the computing system.

In some examples, performing the set of operations to facilitate causing the computing system to run the trained ML model comprises transmitting an instruction configured to cause the computing system to use at least received runtime input data and the trained ML model to generate and output corresponding runtime output data.

In some examples, the computing system is an IoT device, a camera, a television and/or a set-top box. In some examples, the computing system is server connected to an Internet-of-Things (IoT) device.

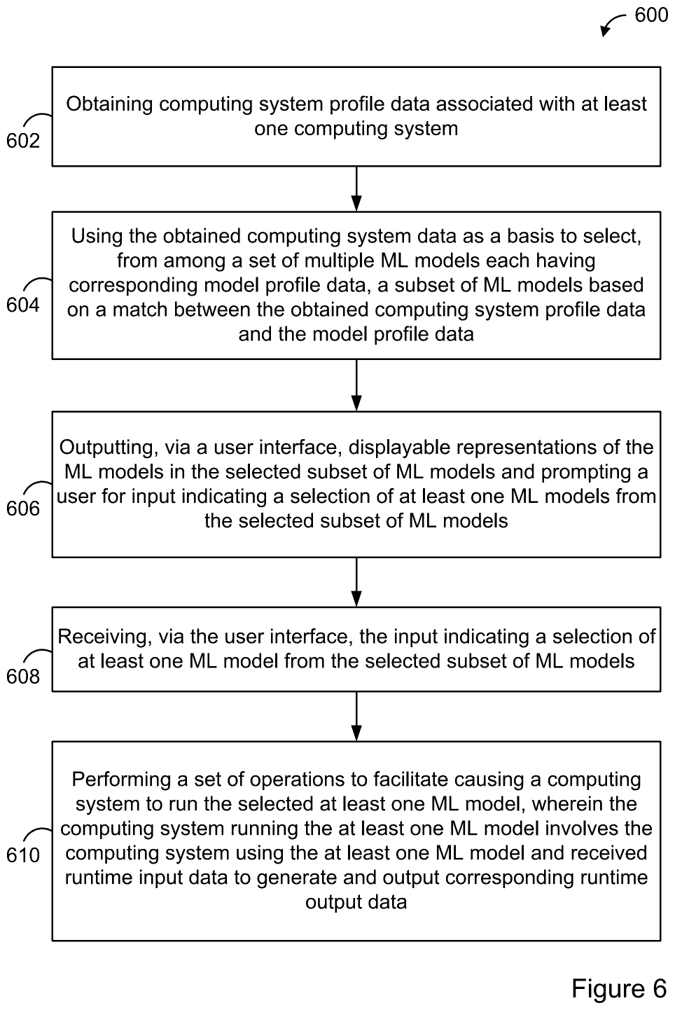

FIG. 6 is a flow chart illustrating an example method 600. The method 600 can be carried out by a ML system, such as the ML system 100 and/or a component thereof, such as the ML model manager 102, or more generally, by a computing system, such as the computing system 200. At block 602, the method 600 includes obtaining computing system profile data associated with at least one computing system. At block 604, the method 600 includes using the obtained computing system data as a basis to select, from among a set of multiple ML models each having corresponding model profile data, a subset of ML models based on a match between the obtained computing system profile data and the model profile data. At block 606, the method 600 includes outputting, via a user interface, displayable representations of the ML models in the selected subset of ML models and prompting a user for input indicating a selection of at least one ML models from the selected subset of ML models. At block 608, the method 600 includes receiving, via the user interface, the input indicating a selection of at least one ML model from the selected subset of ML models. And at block 610, the method 600 includes performing a set of operations to facilitate causing a computing system to run the selected at least one ML model, wherein the computing system running the at least one ML model involves the computing system using the at least one ML model and received runtime input data to generate and output corresponding runtime output data.

In some examples, the obtained computing system profile data associated with at least one computing system specifies at least one computing resource characteristic of the at least one computing system.

In some examples, the model profile data specifies at least one computing resource requirement or preference.

In some examples, the method 600 further includes: determining at least one computing system associated with the user; wherein obtaining computing system profile data associated with at least one computing system comprises obtaining computing system profile data associated with the determined at least one computing system associated with the user.

In some examples, the method 600 further includes: determining at least one computing system in which the user has expressed interest; wherein obtaining computing system profile data associated with at least one computing system comprises obtaining computing system profile data associated with the determined at least one computing system in which the user has expressed interest.

In some examples, the input indicates a selection of multiple ML models from the selected subset of ML models, the method 600 further includes merging the selected multiple models together into a composite ML model, performing the set of operations to facilitate causing the computing system to run the selected at least one ML model includes performing the set of operations to facilitate causing the computing system to run the composite ML model, and the computing system running the composite ML model involves the computing system using at least the composite ML model and received runtime input data to generate and output corresponding runtime output data.

Moreover, each of the examples discussed above in connection with the method 500 are likewise applicable to the method 600.

### IV. Example Variations

Although some of the acts and/or functions described in this disclosure have been described as being performed by a particular entity, the acts and/or functions can be performed by any entity, such as those entities described in this disclosure. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method comprising:
receiving a request to train a machine learning (ML) model and responsively prompting a user for a first input indicating a subject for detection within media;
receiving, via a user interface, the first input;
using at least the received first input as a basis to obtain a set of media related to the subject for detection;
outputting, via the user interface, the obtained set of media and prompting the user for second input indicating subject identification information relating to the subject for detection within the obtained set of media;
receiving, via the user interface, the second input;
using at least (i) the obtained set of media as training input data and (ii) the received second input as training output data, to train the ML model; and
performing a set of operations to facilitate causing a computing system to run the trained ML model, wherein the computing system running the trained ML model comprises the computing system using at least the trained ML model and received runtime input data to generate and output corresponding runtime output data.

2. The method of claim 1, wherein the media is video, the set of media includes multiple images, and the subject identification information specifies whether, for each of the multiple images, the subject for detection is represented within that respective image.

3. The method of claim 2, wherein the subject identification information further specifies, for each of the multiple images, where the subject for detection is represented within that respective image.

4. The method of claim 1, wherein the media is audio, the set of media includes multiple audio clips, and the subject identification information specifies whether, for each of the multiple audio clips, the subject for detection is represented within that respective audio clip.

5. The method of claim 1, wherein using at least the received first input as a basis to obtain the set of media related to the subject for detection comprises:
using at least the received first input to search for media to include in the set of media.

6. The method of claim 1, further comprising:
identifying a media-capturing device associated with the user;
wherein using at least the received first input as a basis to obtain the set of media related to the subject for detection comprises:
using at least the received first input to search, within media captured by the identified media-capturing device, for media to include in the set of media.

7. The method of claim 1, wherein using at least the received first input as a basis to obtain the set of media related to the subject for detection comprises:
using at least the received first input to search for and obtain example media representing the subject for detection;
identifying a media-capturing device associated with the user and obtaining media captured by the identified media-capturing device;
using at least (i) the obtained example media representing the subject for detection and (ii) the obtained media captured by the identified media-capturing device, to synthetically generate media that includes (i) the obtained example media representing the subject for detection and (ii) the obtained media captured by the identified media-capturing device; and
including the synthetically generated media in the obtained set of media.

8. The method of claim 7, wherein the media-capturing device is a camera.

9. The method of claim 1, further comprising:
obtaining user profile data associated with the user;
wherein using at least the received first input as the basis to obtain the set of media related to the subject for detection comprises:
using at least the received first input and the obtained user profile data as a basis to obtain the set of media related to the subject for detection.

10. The method of claim 9, wherein the user profile data indicates a geographic location of the user.

11. The method of claim 1, further comprising:
obtaining computing system profile data associated with the computing system;
wherein using at least the received first input as the basis to obtain the set of media related to the subject for detection comprises:
using at least the received first input and the obtained computing system profile data as a basis to obtain the set of media related to the subject for detection.

12. The method of claim 11, wherein the computing system profile data indicates a geographic location of the computing system.

13. The method of claim 1, wherein performing the set of operations to facilitate causing the computing system to run the trained ML model comprises transmitting an instruction configured to cause a server to transmit the trained ML model to the computing system.

14. The method of claim 1, wherein performing the set of operations to facilitate causing the computing system to run the trained ML model comprises transmitting an instruction configured to cause the computing system to use at least received runtime input data and the trained ML model to generate and output corresponding runtime output data.

15. The method of claim 1, wherein the computing system is an Internet-of-Things (IoT) device.

16. The method of claim 15, wherein the computing system is a camera.

17. The method of claim 15, wherein the computing system is a television or a set-top box.

18. The method of claim 1, wherein the computing system is server connected to an Internet-of-Things (IoT) device.

19. A computing system comprising a processor and a non-transitory computer-readable storage medium having stored thereon program instructions that upon execution by the processor, cause the computing system to perform a set of acts comprising:
receiving a request to train a machine learning (ML) model and responsively prompting a user for a first input indicating a subject for detection within media;
receiving, via a user interface, the first input;
using at least the received first input as a basis to obtain a set of media related to the subject for detection;
outputting, via the user interface, the obtained set of media and prompting the user for second input indicating subject identification information relating to the subject for detection within the obtained set of media;
receiving, via the user interface, the second input;
using at least (i) the obtained set of media as training input data and (ii) the received second input as training output data, to train the ML model; and
performing a set of operations to facilitate causing a computing system to run the trained ML model, wherein the computing system running the trained ML model comprises the computing system using at least the trained ML model and received runtime input data to generate and output corresponding runtime output data.

20. A non-transitory computer-readable storage medium having stored thereon program instructions that upon execution by a processor, cause a computing system to perform a set of acts comprising:
receiving a request to train a machine learning (ML) model and responsively prompting a user for a first input indicating a subject for detection within media;
receiving, via a user interface, the first input;
using at least the received first input as a basis to obtain a set of media related to the subject for detection;
outputting, via the user interface, the obtained set of media and prompting the user for second input indicating subject identification information relating to the subject for detection within the obtained set of media;
receiving, via the user interface, the second input;
using at least (i) the obtained set of media as training input data and (ii) the received second input as training output data, to train the ML model; and
performing a set of operations to facilitate causing a computing system to run the trained ML model, wherein the computing system running the trained ML model comprises the computing system using at least the trained ML model and received runtime input data to generate and output corresponding runtime output data.
